(19) United States
(12) Patent Application Publication
(10) Pub. No.: US 2026/0292622 A1
(43) Pub. Date: Sep. 24, 2026

(54) METHOD AND APPARATUS FOR ENHANCEMENTS ON RANDOM ACCESS CHANNEL (RACH)-LESS HANDOVER

(71) Applicant: MediaTek Singapore Pte. Ltd., Singapore (SG)

(72) Inventor: Wen TANG, Beijing (CN)

(73) Assignee: MediaTek Singapore Pte. Ltd., Singapore (SG)

(21) Appl. No.: 19/473,891

(22) PCT Filed: Jul. 29, 2024
(86) PCT No.: PCT/CN2024/108177

§ 371 Date: Oct. 9, 2025

(30) Foreign Application Priority Data
Sep. 21, 2023 (WO) PCT/CN2023/120481

(51) Int. Cl. H04W 36/00; H04B 17/318; H04W 72/21

(52) U.S. Cl. CPC H04W 36/00725; H04B 17/328; H04W 72/21

(57) ABSTRACT

Various solutions for enhancements on random access channel (RACH)-less handover are described. An apparatus may receive a handover (HO) command for a RACH-less handover from a first network node. The HO command may include one or more parameters specific for the RACH-less handover. The apparatus may perform an initial uplink (UL) transmission of the RACH-less handover to a second network node based on the one or more parameters. Then, the apparatus may monitor a physical downlink control channel (PDCCH) or a physical downlink shared channel (PDSCH) for a completion indication of the RACH-less handover.

### CROSS REFERENCE TO RELATED PATENT APPLICATION(S)

The present disclosure is part of a non-provisional application claiming the priority benefit of PCT Application No. PCT/CN2023/120481, filed 21 Sep. 2023, the content of which herein being incorporated by reference in its entirety.

### TECHNICAL FIELD

The present disclosure is generally related to mobile communications and, more particularly, to enhancements on random access channel (RACH)-less handover with respect to user equipment (UE) and network node in mobile communications.

### BACKGROUND

Unless otherwise indicated herein, approaches described in this section are not prior art to the claims listed below and are not admitted as prior art by inclusion in this section.

For current network implementations, one base station (BS) is operable to provide radio coverage to a specific geographical area using one or more cells to form a radio access network. The BS may support the operations of the cell(s), and each cell may be operable to provide services to at least one user equipment (UE) within its radio coverage. Due to UE mobility (e.g., a UE may move close to the cell edge), the serving cell quality for the UE may be degraded while a neighbor cell quality for the UE may be enhanced. In this case, the UE may perform a handover from the source cell (i.e., the serving cell) to the target cell (e.g., the neighbor cell) in order to be served with better quality. In conventional design of handover, the UE needs to perform a RACH procedure towards the target cell for, e.g., uplink synchronization with the target cell, before a connection with the target cell can be established. Unfavorably, the RACH procedure will impact (e.g., prolong) the handover delay, and random access congestion may occur in the target cell.

To reduce the handover delay and avoid random access congestion, the concept of RACH-less handover is introduced, which allows the UE to skip the RACH procedure and directly access the target cell, e.g., when the UE is in good condition of timing synchronized with the target cell. Currently, it is agreed in 3^{rd} Generation Partnership Project (3GPP) Release 18 that RACH-less handover is to be supported using either pre-allocated grant or dynamic grant. However, details of RACH-less handover have not been fully discussed and some issues need to be solved. For example, one of the issues relate to how to design the handover (HO) command signaling for RACH-less handover. Other issues relate to procedural details for both the cases of using pre-allocated grant and dynamic grant in RACH-less handover.

Therefore, there is a need to provide proper schemes to address these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to enhancements on RACH-less handover. It is believed that the above-described issues would be avoided or otherwise alleviated by implementing one or more of the proposed schemes described herein.

In one aspect, a method may involve an apparatus receiving an HO command for a RACH-less handover from a first network node, wherein the HO command comprises one or more parameters specific for the RACH-less handover. The method may also involve the apparatus performing an initial uplink (UL) transmission of the RACH-less handover to a second network node based on the one or more parameters. The method may further involve the apparatus monitoring a physical downlink control channel (PDCCH) or a physical downlink shared channel (PDSCH) for a completion indication of the RACH-less handover.

In one aspect, an apparatus may comprise a transceiver which, during operation, wirelessly communicates with a first network node or a second network node. The apparatus may also comprise a processor communicatively coupled to the transceiver. The processor, during operation, may perform operations comprising receiving, via the transceiver, an HO command for a RACH-less handover from the first network node, wherein the HO command comprises one or more parameters specific for the RACH-less handover. The processor may also perform operations comprising performing, via the transceiver, an initial UL transmission of the RACH-less handover to the second network node based on the one or more parameters. The processor may further perform operations comprising monitoring, via the transceiver, a PDCCH or a PDSCH for a completion indication of the RACH-less handover.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of HO command signaling for RACH-less handover in accordance with an implementation of the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements on RACH-less handover. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on.

In NTN systems (e.g., IoT NTN systems), due to the satellite always moving, there may be the case where the UE needs to perform a handover to ensure normal system operation. To reduce the handover delay, RACH-less handover is to be supported in 5G NR. However, in current 3GPP Release 18 standards, details of RACH-less handover have not been fully discussed and some issues need to be solved, such as how to design the HO command signaling for RACH-less handover. Additionally, other issues relate to procedural details for RACH-less handover, including retransmission handling, conditions for identifying success and failure of RACH-less handover, timing alignment timer handling, and power control handling, etc.

In view of the above, the present disclosure is motivated by, but not limited to, an NTN scenario, and accordingly proposes a number of schemes pertaining to enhancements on RACH-less handover, aiming to solve the above-described issues. According to the schemes of the present disclosure, explicit procedures for configuring and performing RACH-less handover are proposed to ensure normal operation in both NTN and TN systems.

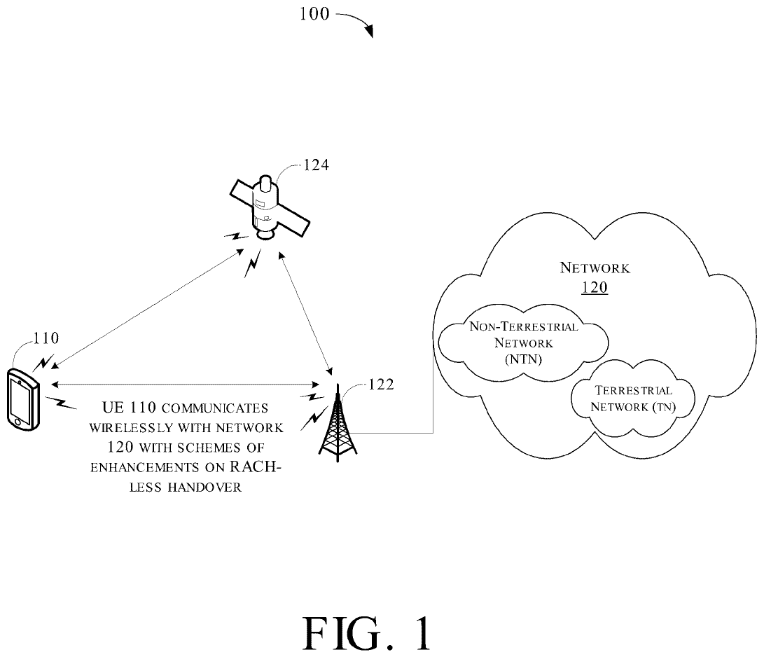

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 122 (e.g., an evolved Node-B (eNB), a Next Generation Node-B (gNB), or a transmission/reception point (TRP)) and/or a non-terrestrial network node 124 (e.g., a satellite). For example, the terrestrial network node 122 and/or the non-terrestrial network node 124 may form an NTN or TN serving cell for wireless communication with the UE 110. In some implementations, the network 120 may be an IoT network (e.g., an NTN/TN IoT network), and the UE 110 may be an IoT device such as an NB-IoT UE or an eMTC UE (e.g., a bandwidth reduced low complexity (BL) UE or a coverage enhancement (CE) UE). In such communication environment, the UE 110, the network 120, and the terrestrial network node 122 and/or the non-terrestrial network node 124 may implement various schemes pertaining to enhancements on RACH-less handover in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In general, an IoT system is mainly divided into NB-IoT and eMTC based on differences in system bandwidth and coverage. Typically, the bandwidth used in NB-IoT is about 200 kilo-hertz (KHz) and supports the transmission of low traffic data at a rate below 100 kilobits per second (Kbps). Conversely, eMTC technology typically utilizes 1.4 mega-hertz (MHz) bandwidth and the maximum data transmission rate is 1 megabits per second (Mbps).

Under a first proposed scheme in accordance with the present disclosure, one or more parameters specific for RACH-less handover may be provided in HO command signaling (e.g., an information element (IE) CG-RRC-Configuration-R18 and an IE RACH-LessHO-r18 included in an RRCReconfiguration message, where the IE CG-RRC-Configuration-R18 includes parameters for configured grant (CG) RACH-less handover and the IE RACH-LessHO-r18 includes parameters for both CG and dynamic grant (DG) RACH-less handover), such that the UE may perform an UL transmission of the RACH-less handover to the target cell based on the one or more parameters and monitor physical downlink control channel (PDCCH) or physical downlink shared channel (PDSCH) for a completion indication of the RACH-less handover.

In some implementations, the one or more parameters specific for RACH-less handover may include at least one of the following: (i) a first parameter (e.g., denoted as autonomousTx-RACHlessHandover) indicating an indication that a configured grant configuration for the RACH-less handover is configured with autonomous transmission; (ii) a second parameter (e.g., denoted as configuredGrantTimer-RACHlessHandover) indicating an initial value of a configured grant timer in multiples of periodicity for the RACH-less handover; (iii) a third parameter (e.g., denoted as cg-RetransmissionTimer-RACHlessHandover or cg-RRC-RetransmissionTimer-r18) indicating an initial value of a configured grant retransmission timer used for the initial transmission of CG with CCCH (for CG-SDT) or DCCH message in multiples of periodicity for the RACH-less handover; the value of cg-RetransmissionTimer-RACHlessHandover is always less than or equal to the value of configuredGrantTimer-RACHlessHandoverlconfiguredGrantTimer, and this field is always configured with INTEGER (1 . . . 64) for RACH-less handover; (iv) a fourth parameter (e.g., denoted as Periodicity-offset) indicating an offset value of a periodicity for a pre-allocated UL grant (i.e., the configured grant Type 1) for the RACH-less handover; (v) a fifth parameter (e.g., denoted as TimeAlignmentTimer-RACHlessHandover) indicating a timing alignment timer for the RACH-less handover (i.e., Rach-LessHO-TimeAlignmentTimer) via 3 bits with component values of {ms500, ms750, ms1280, ms1920, ms2560, ms5120, ms10240, infinity}; if the RACH-less handover signaling (e.g., RACH-LessHO-r18) is configured without a timing alignment timer for RACH-less handover, the timing alignment timer for RACH-less handover is equals to the latest timing alignment timer configured for the source cell; (vi) a sixth parameter (e.g., denoted as CG-StartOffset-RACHlessHandover) indicating an offset value of the start of the initial UL transmission for the RACH-less handover; this field is configured with unit of millisecond (ms) or unit of times of periodicity for RACH-less handover; (vii) a seventh parameter (e.g., denoted as Alpha-RACHlessHandover or rrc-Alpha) indicating one or more alpha values for physical uplink shared channel (PUSCH) for the RACH-less handover; when this field is configured, the UE ignores the p0-PUSCH-Alpha if configured; if not configured and no alpha value for PUSCH for target cell is configured, utilize the alpha value for PUSCH from source cell; (viii) an eighth parameter (e.g., denoted as P0-PUSCH-AlphaSet-RACHlessHandover) indicating one or more alpha values for PUSCH with grant (except msg3) for the RACH-less handover; when this field is absent, the UE applies the value 1 and p0 value for PUSCH with grant (except msg3) in steps of 1 decibel (dB) for RACH-less handover; (ix) a ninth parameter (e.g., denoted as P0-RACHlessHandover or rrc-P0-PUSCH-r18) indicating one or more P0 values for the PUSCH for the RACH-less handover in steps of 1 dB; when this field is configured, the UE ignores the p0-NominalWithoutGrant (or p0-PUSCH-Alpha) if configured; and (x) a tenth parameter (e.g., denoted as initialULReceivedTargetPower) indicating one or more target power levels at network receiver side, where only multiples of 2 decibel-milliwatt (dBm) may be chosen (e.g. −202, −200, −198, . . . ) for each target power level.

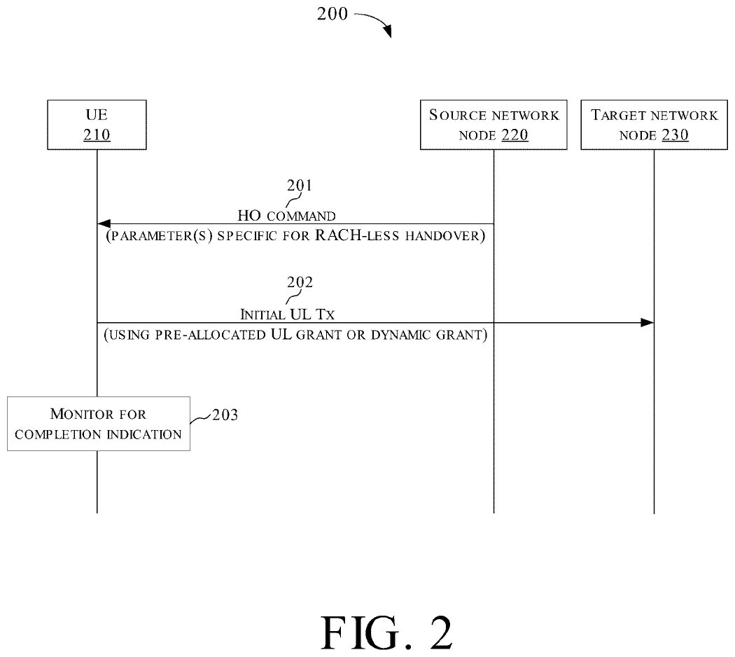

FIG. 2 illustrates an example scenario 200 of HO command signaling for RACH-less handover in accordance with an implementation of the present disclosure. Scenario 200 involves a UE 210 undergoing a RACH-less handover from a source network node 220 (e.g., source gNB) to a target network node 230 (e.g., target gNB). In step 201, the source network node 220 triggers the handover by transmitting an RRCReconfiguration message (i.e., the HO command) to the UE 210, containing the information required to access the target network node 230. Specifically, the RRCReconfiguration message includes parameter(s) specific for RACH-less handover, such as the above-described first to tenth parameters. In step 202, the UE 210 performs an initial UL transmission (e.g., an RRCReconfigurationComplete message) to the target network node 230 based on the one or more parameters included in the RRCReconfiguration message. In step 203, the UE 210 monitor (e.g., a physical downlink control channel (PDCCH) or a physical downlink shared channel (PDSCH)) for a completion indication (e.g., a downlink (DL) assignment for a new transmission, or a UE Contention Resolution Identity medium access control (MAC) control element (CE)) of the RACH-less handover.

Under a second proposed scheme in accordance with the present disclosure, for RACH-less handover, if configured with a pre-allocated UL grant, the UE may perform initial UL transmission based on following procedure, for synchronization signal block (SSB) selection, where retransmission (or autonomous retransmission) can be allowed and the condition for identifying success of RACH-less handover is provided.

The radio resource control (RRC) (i.e., the RRC layer of the communication protocol operated by the UE) may configure the following parameters when the configured grant Type 1 (i.e., the pre-allocated UL grant) for RACH-less handover is configured: (i) cs-RNTI, indicating the configured scheduling-radio network temporary identifier (CS-RNTI for retransmission); (ii) ntn-RSRP-ThresholdSSB, indicating a reference signal received power (RSRP) threshold configured for SSB selection for the pre-allocated UL grant; (iii) periodicity, indicating the periodicity of the pre-allocated UL grant; (iv) timeDomainOffset, indicating the offset of a resource with respect to system frame number (SFN)=timeReferenceSFN in time domain; (v) timeDomainAllocation, indicating the allocation of configured UL grant in time domain which contains startSymbolAndLength (i.e. start and length indicator value (SLIV) in TS 38.214) or startSymbol (i.e. start(S) in TS 38.214); (vi) nrofHARQ-Processes, indicating the number of hybrid automatic repeat request (HARQ) processes for configured grant. Additionally, or optionally, the RRC may configure the following parameter when retransmissions on the configured grant Type 1 (i.e., the pre-allocated UL grant) for RACH-less handover is configured: (i) cg-RetransmissionTimer-RACHlessHandover, indicating the duration after a configured grant (re) transmission of a HARQ process when the UE shall not autonomously retransmit that HARQ process.

For an UL grant configured for configured grant Type 1 (i.e., the pre-allocated UL grant) for RACH-less handover, when the configured grant Type 1 for RACH-less handover is triggered and not terminated, for each configured UL grant valid, the MAC entity (i.e., an entity of the MAC layer of the communication protocol operated by the UE) may proceed as exemplified below in Table 1.

TABLE 1

| 1> | if, after initial transmission for the configured grant Type 1 (i.e., the pre-allocated UL grant) | |
|---|---|---|
| | for RACH-less handover has been performed, confirming the HO completion from network | |
| | (e.g., a DL assignment for a new transmission, or a UE Contention Resolution Identity MAC | |
| | CE) has not been received: | |
| | 2> | the SSB corresponding to the configured UL grant has the same SSB index as the SSB |
| | | selected for initial transmission for RACH-less handover (i.e., retransmission of initial |
| | | transmission of configured grant Type 1 (i.e., the pre-allocated UL grant) for RACH-less |
| | | handover): |

| | |
|---|---|
| 3> | select this SSB; |
| 3> | indicate the SSB index corresponding to the configured UL grant to the lower layer; |
| 3> | consider this configured UL grant as valid. |

| 1> | else if at least one SSB configured for configured grant Type 1 (i.e., the pre-allocated UL | |
|---|---|---|
| | grant) for RACH-less handover with synchronization signal-reference signal received power | |
| | (SS-RSRP) above cg-SDT-RSRP-ThresholdSSB is available: | |
| | 2> | if at least one SSB corresponding to the configured UL grant with SS-RSRP above ntn- |
| | | RSRP-ThresholdSSB is available: |

| | |
|---|---|
| 3> | if this is the initial transmission of for configured grant Type 1 (i.e., the pre-allocated |
| | UL grant) for RACH-less handover after the configured grant Type 1 (i.e., the pre- |
| | allocated UL grant) for RACH-less handover procedure is initiated (i.e., initial |
| | transmission for configured grant Type 1 (i.e., the pre-allocated UL grant) for RACH- |
| | less handover): |

| | |
|---|---|
| 4> | select an SSB with SS-RSRP above ntn-RSRP-ThresholdSSB amongst the SSB(s) |
| | associated with the configured UL grant. |

| | |
|---|---|
| 3> | else if confirming the HO completion from network (e.g. a DL assignment for a new |
| | transmission, or a UE Contention Resolution Identity MAC CE) has been received after |
| | the initial transmission of for configured grant Type 1 (i.e., the pre-allocated UL grant) |
| | for RACH-less handover (i.e., subsequent new transmission for configured grant Type 1 |
| | (i.e., the pre-allocated UL grant) for RACH-less handover): |

| | |
|---|---|
| 4> | if SS-RSRP of the SSB selected for the previous transmission for configured grant |
| | Type 1 (i.e., the pre-allocated UL grant) for RACH-less handover is above ntn-RSRP- |
| | ThresholdSSB and this SSB is associated with this configured UL grant: |

| | |
|---|---|
| 5> | select this SSB. |

| | |
|---|---|
| 4> | else if SS-RSRP of the SSB selected for the previous transmission for configured |
| | grant Type 1 (the pre-allocated UL grant) for RACH-less handover is not above ntn- |
| | RSRP-ThresholdSSB: |

| | |
|---|---|
| 5> | select an SSB with SS-RSRP above ntn-RSRP-ThresholdSSB amongst the SSB(s) |
| | associated with the configured UL grant. |

| | |
|---|---|
| 3> | if SSB is selected above: |

| | |
|---|---|
| 4> | indicate the SSB index to the lower layer; |
| 4> | consider this configured uplink grant as valid. |

| 1> | else confirming the HO completion from network (e.g., a DL assignment for a new | |
|---|---|---|
| | transmission, or a UE Contention Resolution Identity MAC CE) after the initial | |
| | transmission of the configured grant Type 1 (the pre-allocated UL grant) for RACH-less | |
| | handover has been received: | |
| | 2> | the configured grant Type 1 (the pre-allocated UL grant) for RACH-less handover is |
| | | released. |

In other words, the MAC behaviors in Table 1 may be equivalent to the following as exemplified below in Table 2.

TABLE 2

| 1> | if, after the initial transmission of RACH-less handover has been performed according to clause | |
|---|---|---|
| | 5.4.1 and 5.33, PDCCH addressed to the MAC entity's cell-radio network temporary identifier | |
| | (C-RNTI) has not been received: | |
| | 2> | if the SSB corresponding to the configured UL grant has the same SSB index as the SSB |
| | | selected for the initial transmission of RACH-less handover (i.e., retransmission of initial |
| | | transmission of RACH-less handover): |
| | | 3> select this SSB; |
| | | 3> indicate the SSB index corresponding to the configured uplink grant to the lower layer; |
| | | 3> consider this configured uplink grant as valid. |
| 1> | else if at least one SSB corresponding to the configured uplink grant with SS-RSRP above cg- | |
| | RRC-RSRP-ThresholdSSB is available: | |
| | 2> | select an SSB with SS-RSRP above rach-less-RSRP-ThresholdSSB amongst the SSB(s) |
| | | associated with the configured uplink grant; |
| | 2> | indicate the selected SSB index to the lower layer; |
| | 2> | consider this configured uplink grant as valid. |
| 1> | else: | |
| | 2> | consider this configured uplink grant as not valid; |
| | 2> | initiate Random Access procedure in clause 5.1. |

NOTE: When the UE determines if there is an SSB with SS-RSRP above cg-RRC-RSRP-
ThresholdSSB or cg-SDT-RSRP-ThresholdSSB, the UE uses the latest unfiltered L1-RSRP
measurement.

Under a third proposed scheme in accordance with the present disclosure, for RACH-less handover configured with a pre-allocated UL grant, the condition for identifying failure of RACH-less handover is provided. Specifically, if confirming the HO completion from network (e.g., a DL assignment for a new transmission, or a UE Contention Resolution Identity MAC CE) after the initial transmission of the configured grant Type 1 (i.e., the pre-allocated UL grant) for RACH-less handover has not been received before configuredGrantTimer or configuredGrantTimer-RACHlessHandover expires, UE may indicate failure to perform the configured grant Type 1 (i.e., the pre-allocated UL grant) for RACH-less handover procedure to the upper layer.

For an UL grant configured for configured grant Type 1 (i.e., the pre-allocated UL grant) for RACH-less handover, the configured grant timer for the RACH-less handover (e.g., the configuredGrantTimer or configuredGrantTimer-RACHlessHandover) is started when the initial UL transmission is performed using the pre-allocated UL grant, and if the configuredGrantTimer or configuredGrantTimer-RACHlessHandover expires for a HARQ process, the HARQ process may proceed as exemplified below in Table 3.

TABLE 3

| 1> | stop the cg-RetransmissionTimer, if running; | |
|---|---|---|
| 1> | stop the cg-SDT-RetransmissionTimer, if running. | |
| 1> | if a PDCCH addressed to the MAC entity's C-RNTI has not been received after | |
| | initial transmission for the configured grant-small data transmission (CG-SDT) | |
| | with common control channel (CCCH) message to which the | |
| | configuredGrantTimer corresponds: | |
| | 2> | indicate failure to perform SDT procedure to the upper layer. |
| 1> | stop the cg-RetransmissionTimer-RACHlessHandover, if running. | |
| 1> | if confirming the HO completion from network (e.g., a DL assignment for a | |
| | new transmission, or a UE Contention Resolution Identity MAC CE) after | |
| | the initial transmission of the configured grant Type 1 (i.e., the pre- | |
| | allocated UL grant) for RACH-less handover has not been received: | |
| | 2> | indicate failure to perform configured grant Type 1 (i.e., the pre-allocated |
| | | UL grant) for RACH-less handover procedure to the upper layer. |

Under a fourth proposed scheme in accordance with the present disclosure, the timing alignment timer for RACH-less handover (e.g., Rach-LessHO-TimeAlignmentTimer) is started when the HO command signaling for RACH-less handover (e.g., RACH-LessHO-r18) is configured, after the start of T304 and before/after/at the start of T430.

The timing alignment timer for RACH-less handover (e.g., Rach-LessHO-TimeAlignmentTimer) may be configured in HO command signaling for RACH-less handover (e.g., RACH-LessHO-r18) via 3 bits with component values of {ms500, ms750, ms1280, ms1920, ms2560, ms5120, ms10240, infinity}. If the HO command signaling for RACH-less handover (e.g., RACH-LessHO-r18) is configured without the timing alignment timer for RACH-less handover (e.g., Rach-LessHO-TimeAlignmentTimer), the timing alignment timer for RACH-less handover (e.g., Rach-LessHO-TimeAlignmentTimer) is equals to the latest timing alignment timer configured for the source cell.

For handling reconfiguration with sync, the RRC may proceed as exemplified below in Table 4.

TABLE 4
...

| 3> | if rach-LessHO is included: | |
|---|---|---|
| | 4> | configure lower layers in accordance with rach-LessHO for the target SpCell; |
| | 4> | if Rach-LessHO-TimeAlignmentTimer is configured; |
| | | 5> instruct the MAC entity to start the Rach-LessHO-TimeAlignmentTimer; |
| | 4> | else; |
| | | 5> instruct the MAC entity to start the TimeAlignmentTimer; |

The RRC may configure the following parameters for the maintenance of UL time alignment: (i) timeAlignmentTimer (per TAG) which controls how long the MAC entity considers the Serving Cells belonging to the associated TAG to be uplink time aligned; (ii) inactivePosSRS-TimeAlignmentTimer which controls how long the MAC entity considers the positioning sounding reference signal (SRS) transmission in RRC_INACTIVE in clause 5.26 of TS 38.321 to be uplink time aligned; (iii) cg-SDT-TimeAlignmentTimer which controls how long the MAC entity considers the UL transmission for CG-SDT to be uplink time aligned; (iv) Rach-LessHO-TimeAlignmentTimer which controls how long the MAC entity considers the UL transmission for RACH-less handover to be uplink time aligned. For handling maintenance of UL time alignment, the MAC entity may proceed as exemplified below in Table 5.

TABLE 5
...

| | |
|---|---|
| 1> | when instruction from the upper layer has been received for starting the Rach-LessHO- |
| | TimeAlignmentTimer: |
| | 2> start the Rach-LessHO-TimeAlignmentTimer. |
| 1> | when the RACH-less handover procedure is ongoing and when instruction from the |
| | upper layer has been received for starting the TimeAlignmentTimer: |
| | 2> start the TimeAlignmentTimer from the source cell. |

Under a fifth proposed scheme in accordance with the present disclosure, power control rules for RACH-less handover are provided for both the cases of using pre-allocated grant and dynamic grant in RACH-less handover. In option 1, the same power control rule may be utilized for initial UL transmission and retransmission(s) of the configured grant Type 1 (i.e., the pre-allocated UL grant) for RACH-less handover. In option 2, different power control rules may be utilized for initial UL transmission and retransmission(s) of the configured grant Type 1 (i.e., the pre-allocated UL grant) for RACH-less handover. In option 3, the same power control rule may be utilized for initial UL transmission and retransmission of the dynamic grant for RACH-less handover. In option 4, different power control rules may be utilized for initial UL transmission and retransmission of the dynamic grant for RACH-less handover.

For options 1 and 2, the following new RRC parameters may be introduced: (i) P0-RACHlessHandover (optional), indicating (sets of) P0 value for PUSCH for RACH-less handover in steps of 1 dB, e.g., INTEGER (−16 . . . 15); when this field is configured, the UE ignores the p0 NominalWithoutGrant if configured; (ii) Alpha-RACHlessHandover (optional), indicating (sets of) alpha value for PUSCH for RACH-less handover, e.g., ENUMERATED {alpha0, alpha04, alpha05, alpha06, alpha07, alpha08, alpha09, alpha1}, where alpha0 indicates value 0 is used, alpha04 indicates value 4 is used, and so on; (iii) P0-PUSCH-AlphaSet-RACHlessHandover (optional), indicating (sets of) alpha value for PUSCH with grant (except msg3); when the field is absent, the UE applies the value 1 and p0 value for PUSCH with grant (except msg3) in steps of 1 dB for RACH-less handover.

Additionally, for options 1 and 2, the power control rules may be formulated as exemplified below in Table 6.

TABLE 6
For a PUSCH (re)transmission configured by ConfiguredGrantConfig, j = 1,
P_{O}_{_{—}}_{NOMINAL,PUSCH,f,c}(1) is provided by p0-NominalWithoutGrant, or P_{O}_{_{—}}_{NOMINAL,PUSCH,f,c}(1) =
P_{O}_{_{—}}_{NOMINAL,PUSCH,f,c}(0) if p0-NominalWithoutGrant is not provided.
...
- else, P_{O}_{_{—}}_{UE}_{_{—}}_{PUSCH,b,f,c}(1) is provided by p0 obtained from p0-PUSCH-Alpha in
ConfiguredGrantConfig that provides an index P0-PUSCH-AlphaSetId to a set of P0-PUSCH-
AlphaSet, or by sdt-P0-PUSCH for a PUSCH (re)transmission as described in clause 19.1, or P0
-RACHlessHandover for a RACH less Handover PUSCH (re)transmission or p0 obtained
from p0-PUSCH-Alpha in ConfiguredGrantConfig that provides an index P0-PUSCH-
AlphaSetId to a set of P0-PUSCH-AlphaSet from source cell for a RACH-less handover
PUSCH (re)transmission or p0 obtained from p0-PUSCH-Alpha in ConfiguredGrantConfig
that provides an index P0-PUSCH-AlphaSetId to a set of P0-PUSCH-AlphaSet-
RACHlessHandover for a RACH-less handover PUSCH (re)transmission (i.e., or by rrc-P0-
PUSCH for a PUSCH (re)transmission as described in clause 22.1), for active UL BWP b of
carrier f of serving cell c,

| | |
|---|---|
| - | For α_{b,f,c}(j) |
| - | For j = 1, |

...

| - | else α_{b,f,c}(1) is provided by alpha obtained from p0-PUSCH-Alpha in | |
|---|---|---|
| | ConfiguredGrantConfig providing an index P0-PUSCH-AlphaSetId to a set of P0-PUSCH- | |
| | AlphaSet, or by sdt-Alpha for a PUSCH (re)transmission as described in clause 19.1, or | |
| | Alpha-RACHlessHandover for a RACH less Handover PUSCH (re)transmission or | |
| | alpha obtained from p0-PUSCH-Alpha in ConfiguredGrantConfig providing an index | |
| | P0-PUSCH-AlphaSetId to a set of P0-PUSCH-AlphaSet from source cell for a RACH | |
| | less Handover PUSCH (re)transmission or alpha obtained from p0-PUSCH-Alpha in | |
| | ConfiguredGrantConfig providing an index P0-PUSCH-AlphaSetId to a set of P0- | |
| | PUSCH-AlphaSet- RACHlessHandover for a RACH-less handover PUSCH | |
| | (re)transmission (i.e., or by rrc-Alpha for a PUSCH (re)transmission as described in | |
| | clause 22.1), for active UL BWP b of carrier f of serving cell c | |
| - | PL_{b,f,c}(q_{d}) is a downlink pathloss estimate in dB calculated by the UE using reference | |
| | signal (RS) index q_{d} for the active DL BWP, as described in clause 12, of carrier f of | |
| | serving cell c | |
| | - | If the UE is not provided PUSCH-PathlossReferenceRS and enableDefaultBeamPL- |
| | | ForSRS, or before the UE is provided dedicated higher layer parameters, the UE calculates |
| | | PL_{b,f,c}(q_{d}) using a RS resource from an SS/PBCH block with same SS/PBCH block index |
| | | as the one the UE uses to obtain MIB |

For options 3 and 4, the following new RRC parameters may be introduced: (i) initialULReceivedTargetPower (optional), indicating the (sets of) target power level at the network receiver side; only multiples of 2 dBm may be chosen (e.g. −202, −200, −198, . . . ) for each target power level, e.g., INTEGER (−202 . . . 60); (ii) Alpha-RACHlessHandover (optional), indicating the (sets of) alpha value for PUSCH for RACH-less handover, e.g., ENUMERATED {alpha0, alpha04, alpha05, alpha06, alpha07, alpha08, alpha09, alpha1}, where alpha0 indicates value 0 is used, alpha04 indicates value 4 is used, and so on.

Additionally, for options 3 and 4, the power control rules may be formulated as exemplified below in Table 7.

TABLE 7

| | |
|---|---|
| - | P_{O}_{_{—}}_{PUSCH,b,f,c}(j) is a parameter composed of the sum of a component P_{O}_{_{—}}_{NOMINAL,PUSCH,f,c}(1) |
| | and a component P_{O}_{_{—}}_{UE}_{_{—}}_{PUSCH,b,f,c}(j) where j ∈ {0,1, ..., J − 1}. |

...

| | |
|---|---|
| - | If a UE established dedicated RRC connection using a RACH less handover procedure, as |
| | described in TS 38.321 , and is not provided P0-PUSCH-AlphaSet or for a PUSCH |
| | (re)transmission corresponding to a dynamic UL grant as described in TS 38.321, |
| | j = 0, P_{O}_{_{—}}_{UE}_{_{—}}_{PUSCH,b,f,c}(0) = 0, and P_{O}_{_{—}}_{NOMINAL,PUSCH,f,c}(0) = P_{O}_{_{—}}_{PRE} + Δ_{PREAMBLE,Msg3}, |
| | where P_{O}_{_{—}}_{PRE} is provided by preambleReceivedTargetPower and Δ_{PREAMBLE}_{_{—}}_{Msg3} is |
| | provided by msg3-DeltaPreamble, or Δ_{PREAMBLE,Msg3} = 0 dB if msg3-DeltaPreamble is not |
| | provided and P_{O}_{_{—}}_{PRE} = 0 dB if msg3-DeltaPreamble is not provided , for carrier f of |
| | serving cell c, |
| - | For α_{b,f,c}(j) |
| - | For j = 0, |

...

| | |
|---|---|
| - | or α_(b,f,c) (j) is the value of Alpha-RACHlessHandover for a RACH less Handover |
| | PUSCH (re)transmission |
| - | else, α_{b,f,c}(0) = 1 |
| - | PL_{b,f,c}(q_{d}) is a downlink pathloss estimate in dB calculated by the UE using reference signal |
| | (RS) index q_{d} for the active DL BWP, as described in clause 12, of carrier f of serving cell c |

| | |
|---|---|
| - | If the UE is not provided PUSCH-PathlossReferenceRS and enableDefaultBeamPL- |
| | ForSRS, or before the UE is provided dedicated higher layer parameters, the UE calculates |
| | PL_{b,f,c}(q_{d}) |

| | |
|---|---|
| - | using a RS resource from an SS/PBCH block with same SS/PBCH block index as the one |
| | the UE uses to obtain MIB |
| - | if the UE is provided ntn-RACH-LessHO in ReconfigurationWithSync using the same |
| | SSB index as the SSB selected for initial transmission for RACH less Handover with |
| | same quasi co-location properties as for PDCCH receptions, as described in Clause |
| | 10.1, in controlResourceSetZero provided in ServingCellConfigCommon of |
| | ReconfigurationWithSync |

### Illustrative Implementations

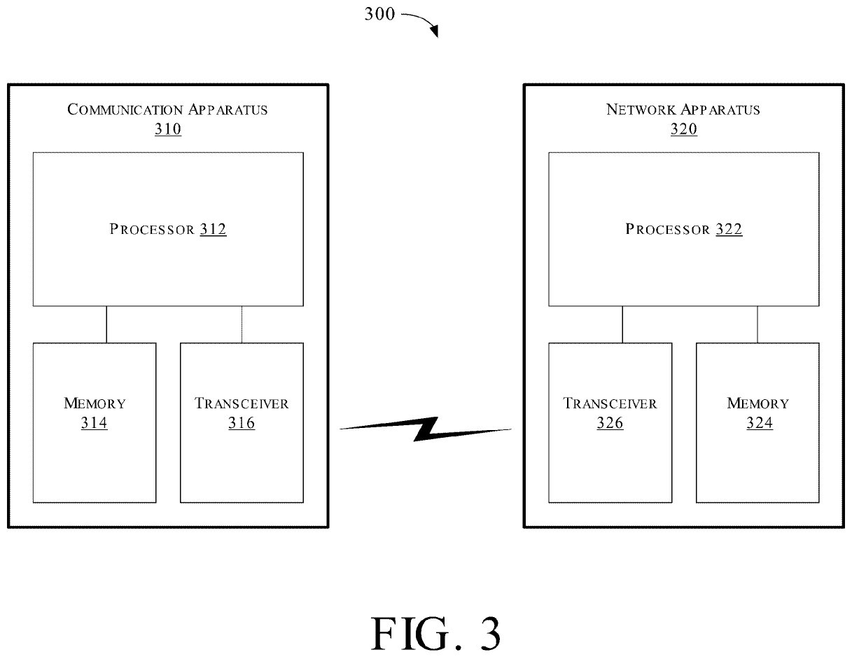

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to enhancements on RACH-less handover, including scenarios/schemes described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 310 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a satellite, a BS, a small cell, a router or a gateway of an IoT network. For instance, network apparatus 320 may be implemented in a satellite or an eNB/gNB/TRP in a 4G/5G, NR, IoT, NB-IoT or IIoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks, including RACH-less handover, in a device (e.g., as represented by communication apparatus 310) and a network node (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, transceiver 316 may be capable of wirelessly communicating with different types of UEs and/or wireless networks of different radio access technologies (RATs), such as 4G/5G/B5G/6G. In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, network apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, communication apparatus 310 may further include a memory 314 coupled to processor 312 and capable of being accessed by processor 312 and storing data therein. In some implementations, network apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 310 and network apparatus 320 may be a communication entity capable of communicating with each other using various proposed schemes in accordance with the present disclosure. For illustrative purposes and without limitation, a description of capabilities of communication apparatus 310, as a UE, and network apparatus 320, as a network node (e.g., satellite or BS), is provided below with process 400.

### Illustrative Processes

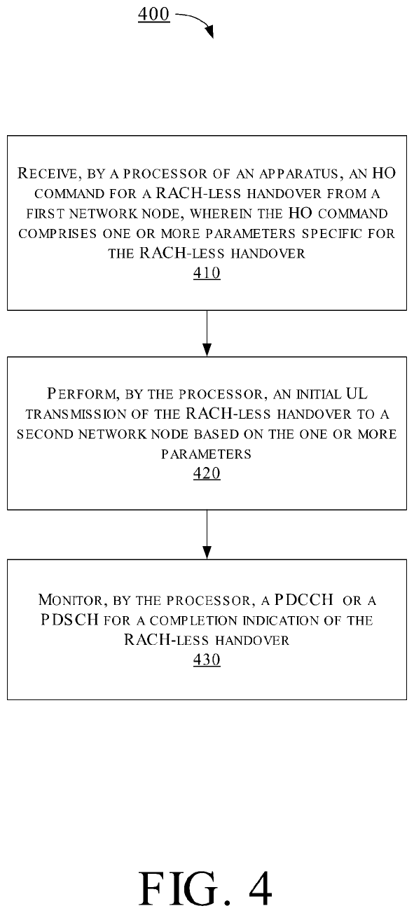

FIG. 4 illustrates an example process 400 in accordance with an implementation of the present disclosure. Process 400 may be an example implementation of above scenarios/schemes, whether partially or completely, with respect to enhancements on RACH-less handover. Process 400 may represent an aspect of implementation of features of communication apparatus 310. Process 400 may include one or more operations, actions, or functions as illustrated by one or more of blocks 410 to 430. Although illustrated as discrete blocks, various blocks of Process 400 may be divided into additional blocks, combined into fewer blocks, or eliminated, depending on the desired implementation. Moreover, the blocks of Process 400 may be executed in the order shown in FIG. 4 or, alternatively, in a different order. Process 400 may be implemented by communication apparatus 310 or any suitable UE or machine type devices. Solely for illustrative purposes and without limitation, Process 400 is described below in the context of communication apparatus 310. Process 400 may begin at block 410.

At block 410, process 400 may involve processor 312 of communication apparatus 310 receiving, via transceiver 316, an HO command for a RACH-less handover from a first network node, wherein the HO command comprises one or more parameters specific for the RACH-less handover. Process 400 may proceed from block 410 to block 420.

At block 420, process 400 may involve processor 312 performing, via transceiver 316, an initial UL transmission of the RACH-less handover to a second network node based on the one or more parameters. Process 400 may proceed from block 420 to block 430.

At block 430, process 400 may involve processor 312 monitoring, via transceiver 316, a PDCCH or a PDSCH for a completion indication of the RACH-less handover.

In some implementations, the one or more parameters may include at least one of the following: (i) a first parameter (e.g., denoted as autonomousTx-RACHlessHandover) indicating an indication that a configured grant configuration for the RACH-less handover is configured with autonomous transmission; (ii) a second parameter (e.g., denoted as configuredGrantTimer-RACHlessHandover) indicating an initial value of a configured grant timer in multiples of periodicity for the RACH-less handover; (iii) a third parameter (e.g., denoted as cg-RetransmissionTimer-RACHlessHandover) indicating an initial value of a configured retransmission timer in multiples of periodicity for the RACH-less handover; (iv) a fourth parameter (e.g., denoted as Periodicity-offset) indicating an offset value of a periodicity for a pre-allocated UL grant (i.e., the configured grant Type 1) for the RACH-less handover; (v) a fifth parameter (e.g., denoted as TimeAlignmentTimer-RACHlessHandover) indicating a timing alignment timer for the RACH-less handover (i.e., Rach-LessHO-TimeAlignmentTimer) via 3 bits with component values of {ms500, ms750, ms1280, ms1920, ms2560, ms5120, ms10240, infinity}; (vi) a sixth parameter (e.g., denoted as CG-StartOffset-RACHlessHandover) indicating an offset value of the start of the initial UL transmission for the RACH-less handover; (vii) a seventh parameter (e.g., denoted as Alpha-RACHlessHandover) indicating one or more alpha values for PUSCH for the RACH-less handover; (viii) an eighth parameter (e.g., denoted as P0-PUSCH-AlphaSet-RACHlessHandover) indicating one or more alpha values for PUSCH with grant (except msg3) for the RACH-less handover; (ix) a ninth parameter (e.g., denoted as P0-RACHlessHandover) indicating one or more P0 values for the PUSCH for the RACH-less handover in steps of 1 dB; and (x) a tenth parameter (e.g., denoted as initialULReceivedTargetPower) indicating one or more target power levels at network receiver side.

In some implementations, in an event that the initial UL transmission is performed using a pre-allocated UL grant, a retransmission (i.e., autonomous retransmission) of the initial UL transmission is allowed.

In some implementations, process 400 may further involve processor 312 selecting an SSB and determining the pre-allocated UL grant as valid for the retransmission, in an event that the PDCCH addressed to a C-RNTI has not been received and the SSB corresponding to the pre-allocated UL grant has a same SSB index as an SSB selected for the initial UL transmission. Alternatively, process 400 may further involve processor 312 selecting an SSB and determining the pre-allocated UL grant as valid for the retransmission, in an event that at least one SSB corresponding to the pre-allocated UL grant with an SS-RSRP above an SSB threshold for RACH-less handover is available and the SSB has an SS-RSRP above the SSB threshold for RACH-less handover amongst one or more SSBs associated with the pre-allocated UL grant.

In some implementations, process 400 may further involve processor 312 determining that the RACH-less handover is successfully completed in an event that the initial UL transmission is performed using a pre-allocated UL grant and the completion indication of the RACH-less handover has been received after the initial UL transmission.

In some implementations, the completion indication of the RACH-less handover comprises a DL assignment for a new transmission, or a UE Contention Resolution Identity MAC CE.

In some implementations, process 400 may further involve processor 312 starting a configured grant timer for the RACH-less handover when the initial UL transmission is performed using a pre-allocated UL grant. Additionally, process 400 may involve processor 312 determining that the RACH-less handover is failed in an event that the completion indication of the RACH-less handover has not been received before the configured grant timer expires.

In some implementations, process 400 may further involve processor 312 starting a configured grant timer for the RACH-less handover when the initial UL transmission is performed using a pre-allocated UL grant. Additionally, process 400 may involve processor 312 stopping a configured retransmission timer for the RACH-less handover in an event that the configured grant timer expires.

In some implementations, process 400 may further involve processor 312 starting a timing alignment timer for the RACH-less handover responsive to that the HO command comprises the one or more parameters specific for the RACH-less handover.

In some implementations, process 400 may further involve processor 312, in an event that each of the seventh parameter, the eighth parameter, and the ninth parameter indicates only one value, applying a same power control rule for the initial UL transmission and a retransmission of the initial UL transmission based on the only value of each of the seventh parameter, the eighth parameter, and the ninth parameter. Alternatively, process 400 may further involve processor 312, in an event that each of the seventh parameter, the eighth parameter, and the ninth parameter indicates multiple values, applying different power control rules for the initial UL transmission and a retransmission of the initial UL transmission based on the multiple values of each of the seventh parameter, the eighth parameter, and the ninth parameter.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a handover (HO) command for a random access channel (RACH)-less handover from a first network node, wherein the HO command comprises one or more parameters specific for the RACH-less handover;
performing, by the processor, an initial uplink (UL) transmission of the RACH-less handover to a second network node based on the one or more parameters; and
monitoring, by the processor, a physical downlink control channel (PDCCH) or a physical downlink shared channel (PDSCH) for a completion indication of the RACH-less handover.

2. The method of claim 1, wherein the one or more parameters comprise at least one of the following:
a first parameter indicating an indication that a configured grant configuration for the RACH-less handover is configured with autonomous transmission;
a second parameter indicating an initial value of a configured grant timer for the RACH-less handover;
a third parameter indicating an initial value of a configured retransmission timer for the RACH-less handover;
a fourth parameter indicating an offset value of a periodicity for a pre-allocated UL grant for the RACH-less handover;
a fifth parameter indicating a timing alignment timer for the RACH-less handover;
a sixth parameter indicating an offset value of a start of the initial UL transmission for the RACH-less handover;
a seventh parameter indicating one or more alpha values for physical uplink shared channel (PUSCH) for the RACH-less handover;
an eighth parameter indicating one or more alpha values for PUSCH with grant for the RACH-less handover;
a ninth parameter indicating one or more P0 values for the PUSCH for the RACH-less handover in steps of 1 decibel (dB); and
a tenth parameter indicating one or more target power levels at network receiver side.

3. The method of claim 1, wherein, in an event that the initial UL transmission is performed using a pre-allocated UL grant, a retransmission of the initial UL transmission is allowed.

4. The method of claim 3, further comprising:
selecting, by the processor, a synchronization signal block (SSB) and determining the pre-allocated UL grant as valid for the retransmission, in an event that the PDCCH addressed to a cell-radio network temporary identifier (C-RNTI) has not been received and the SSB corresponding to the pre-allocated UL grant has a same SSB index as an SSB selected for the initial UL transmission; or
selecting, by the processor, an SSB and determining the pre-allocated UL grant as valid for the retransmission, in an event that at least one SSB corresponding to the pre-allocated UL grant with a synchronization signal-reference signal received power (SS-RSRP) above an SSB threshold for RACH-less handover is available and the SSB has an SS-RSRP above the SSB threshold for RACH-less handover amongst one or more SSBs associated with the pre-allocated UL grant.

5. The method of claim 1, further comprising:
determining, by the processor, that the RACH-less handover is successfully completed in an event that the initial UL transmission is performed using a pre-allocated UL grant and the completion indication of the RACH-less handover has been received after the initial UL transmission.

6. The method of claim 1, wherein the completion indication of the RACH-less handover comprises a downlink (DL) assignment for a new transmission, or a user equipment (UE) Contention Resolution Identity medium access control (MAC) control element (CE).

7. The method of claim 1, further comprising:
starting, by the processor, a configured grant timer for the RACH-less handover when the initial UL transmission is performed using a pre-allocated UL grant; and
determining, by the processor, that the RACH-less handover is failed in an event that the completion indication of the RACH-less handover has not been received before the configured grant timer expires.

8. The method of claim 1, further comprising:
starting, by the processor, a configured grant timer for the RACH-less handover when the initial UL transmission is performed using a pre-allocated UL grant; and
stopping, by the processor, a configured retransmission timer for the RACH-less handover in an event that the configured grant timer expires.

9. The method of claim 1, further comprising:
starting, by the processor, a timing alignment timer for the RACH-less handover responsive to that the HO command comprises the one or more parameters specific for the RACH-less handover.

10. The method of claim 2, further comprising:
in an event that each of the seventh parameter, the eighth parameter, and the ninth parameter indicates only one value, applying, by the processor, a same power control rule for the initial UL transmission and a retransmission of the initial UL transmission based on the only value of each of the seventh parameter, the eighth parameter, and the ninth parameter; or
in an event that each of the seventh parameter, the eighth parameter, and the ninth parameter indicates multiple values, applying, by the processor, different power control rules for the initial UL transmission and a retransmission of the initial UL transmission based on the multiple values of each of the seventh parameter, the eighth parameter, and the ninth parameter.

11. An apparatus, comprising:
a transceiver which, during operation, wirelessly communicates with a first network node or a second network node; and
a processor communicatively coupled to the transceiver such that, during operation, the processor performs operations comprising:
receiving, via the transceiver, a handover (HO) command for a random access channel (RACH)-less handover from the first network node, wherein the HO command comprises one or more parameters specific for the RACH-less handover;
receiving, via the transceiver, a downlink control information (DCI) from the network node, wherein the DCI indicates a scheduling of multiple transport blocks (TBs) associated with the HARQ processes in a narrowband physical downlink shared channel (NPDSCH);
performing, via the transceiver, an initial uplink (UL) transmission of the RACH-less handover to the second network node based on the one or more parameters; and
monitoring, via the transceiver, a physical downlink control channel (PDCCH) or a physical downlink shared channel (PDSCH) for a completion indication of the RACH-less handover.

12. The apparatus of claim 11, wherein the one or more parameters comprise at least one of the following:
a first parameter indicating an indication that a configured grant configuration for the RACH-less handover is configured with autonomous transmission;
a second parameter indicating an initial value of a configured grant timer for the RACH-less handover;
a third parameter indicating an initial value of a configured retransmission timer for the RACH-less handover;
a fourth parameter indicating an offset value of a periodicity for a pre-allocated UL grant for the RACH-less handover;
a fifth parameter indicating a timing alignment timer for the RACH-less handover;
a sixth parameter indicating an offset value of a start of the initial UL transmission for the RACH-less handover;
a seventh parameter indicating one or more alpha values for physical uplink shared channel (PUSCH) for the RACH-less handover;
an eighth parameter indicating one or more alpha values for PUSCH with grant for the RACH-less handover;
a ninth parameter indicating one or more P0 values for the PUSCH for the RACH-less handover in steps of 1 decibel (dB); and
a tenth parameter indicating one or more target power levels at network receiver side.

13. The apparatus of claim 11, wherein, in an event that the initial UL transmission is performed using a pre-allocated UL grant, a retransmission of the initial UL transmission is allowed.

14. The apparatus of claim 13, wherein, during operation, the processor further performs operations comprising:
selecting a synchronization signal block (SSB) and determining the pre-allocated UL grant as valid for the retransmission, in an event that the PDCCH addressed to a cell-radio network temporary identifier (C-RNTI) has not been received and the SSB corresponding to the pre-allocated UL grant has a same SSB index as an SSB selected for the initial UL transmission; or
selecting, by the processor, an SSB and determining the pre-allocated UL grant as valid for the retransmission, in an event that at least one SSB corresponding to the pre-allocated UL grant with a synchronization signal-reference signal received power (SS-RSRP) above an SSB threshold for RACH-less handover is available and the SSB has an SS-RSRP above the SSB threshold for RACH-less handover amongst one or more SSBs associated with the pre-allocated UL grant.

15. The apparatus of claim 11, wherein, during operation, the processor further performs operations comprising:
determining that the RACH-less handover is successfully completed in an event that the initial UL transmission is performed using a pre-allocated UL grant and the completion indication of the RACH-less handover has been received after the initial UL transmission.

16. The apparatus of claim 11, wherein the completion indication of the RACH-less handover comprises a downlink (DL) assignment for a new transmission, or a user equipment (UE) Contention Resolution Identity medium access control (MAC) control element (CE).

17. The apparatus of claim 11, wherein, during operation, the processor further performs operations comprising:
starting a configured grant timer for the RACH-less handover when the initial UL transmission is performed using a pre-allocated UL grant; and
determining that the RACH-less handover is failed in an event that the completion indication of the RACH-less handover has not been received before the configured grant timer expires.

18. The apparatus of claim 11, wherein, during operation, the processor further performs operations comprising:
starting a configured grant timer for the RACH-less handover when the initial UL transmission is performed using a pre-allocated UL grant; and
stopping a configured retransmission timer for the RACH-less handover in an event that the configured grant timer expires.

19. The apparatus of claim 11, wherein, during operation, the processor further performs operations comprising:
starting a timing alignment timer for the RACH-less handover responsive to that the HO command comprises the one or more parameters specific for the RACH-less handover.

20. The apparatus of claim 12, wherein, during operation, the processor further performs operations comprising:
in an event that each of the seventh parameter, the eighth parameter, and the ninth parameter indicates only one value, applying a same power control rule for the initial UL transmission and a retransmission of the initial UL transmission based on the only value of each of the seventh parameter, the eighth parameter, and the ninth parameter; or
in an event that each of the seventh parameter, the eighth parameter, and the ninth parameter indicates multiple values, applying different power control rules for the initial UL transmission and a retransmission of the initial UL transmission based on the multiple values of each of the seventh parameter, the eighth parameter, and the ninth parameter.
